(19) United States
(12) Patent Application Publication
(10) Pub. No.: US 2005/0148460 A1
(43) Pub. Date: Jul. 7, 2005

(54) Catalyst components and their use in the polymerization of olefins

(76) Inventors: Vladimir Marin, Houston, TX (US); Abbas Razavi, Mons (BE)

Correspondence Address: David J. Alexander;Fina Technology, Inc., P.O. Box 674411, Houston, TX, 77267-4411, US

(21) Appl. No.: 10/751,243

(22) Filed: Jan. 2, 2004

(51) Int. Cl. C07F 17/00; B01J 31/00

(52) U.S. Cl. 502/152; 556/43; 556/60

(57) ABSTRACT

Catalyst compositions and processes for the polymerization of ethylenically unsaturated monomers to produce polymers specific to the polymerization of propylene to produce isotactic polypropylene and copolymer, specifically an ethylene-propylene copolymer. An olefin polymerization catalyst is characterized by the formula:
B(FluA)MQₙ wherein Flu is a fluorenyl group substituted at the 4(5) position by a bulky hydrocarbyl group having at least 3 carbon atoms, A is a substituted or unsubstituted cyclopentadienyl or indenyl group or a heteroorgano group, XR, in which X is a heteroatom from Group 15 or 16 such as nitrogen. R is an alkyl group or cycloalkyl group or a mononuclear aromatic group which may be substituted or unsubstituted. B is a structural bridge which imparts stereorigidity to the ligand structure. The bridge B is characterized by the formula ER′R″, in which E is a carbon, silicon or germanium atom, and R′ and R″ are each independently an alkyl group, an aromatic group or a cycloalkyl group. M is a Group 4 or Group 5 transition metal such as titanium, zirconium or hafnium. Q is chlorine, bromine, iodine, an alkyl group, an amino group or an aromatic group. n is 1 or 2. The fluorenyl group may be substituted at both of the 4 or 5 positions with a bulky hydrocarbyl group containing at least 3 carbon atoms. A may take the form of an indenyl group which is substituted or unsubstituted, or a cyclopentadienyl group which is substituted at the 3 or the 3 and 5 positions. The fluorenyl group may be mono-substituted at the 4 (or 5) position and is otherwise unsubstituted or is di-substituted at the 2,7 positions with alkyl or phenyl or substituted phenyl groups.

### FIELD OF THE INVENTION

This invention relates to olefin polymerization catalysts and their use in the polymerization of ethylenically unsaturated monomers.

### BACKGROUND OF THE INVENTION

Olefin polymers such as polyethylene, polypropylene, which may be atactic or stereospecific, such as isotactic or syndiotactic, and ethylene-higher alpha olefin copolymers, such as ethylene-propylene copolymers can be produced under various polymerization conditions and employing various polymerization catalysts. Such polymerization catalysts include Ziegler-Natta catalysts and non-Ziegler-Natta catalysts, such as metallocenes and other transition metal catalysts which are typically employed in conjunction with one or more co-catalysts. The polymerization catalysts may be supported or unsupported.

The alpha olefin homopolymers or copolymers may be produced under various conditions in polymerization reactors which may be batch type reactors or continuous reactors. Continuous polymerization reactors typically take the form of loop-type reactors in which the monomer stream is continuously introduced and a polymer product is continuously withdrawn. For example, polymers such as polypropylene, polyethylene or ethylene-propylene copolymers involve the introduction of the monomer stream into the continuous loop-type reactor along with an appropriate catalyst system to produce the desired olefin homopolymer or copolymer. The resulting polymer is withdrawn from the loop-type reactor in the form of a “fluff” which is then processed to produce the polymer as a raw material in particulate form as pellets or granules. In the case of C₃₊ alpha olefins, such a propylene or substituted ethylenically unsaturated monomers such as styrene or vinyl chloride, the resulting polymer product may be characterized in terms of stereoregularity, such as in the case of, for example, isotactic polypropylene or syndiotactic polypropylene.

The structure of isotactic polypropylene can be described as one having the methyl groups attached to the tertiary carbon atoms of successive monomeric units falling on the same side of a hypothetical plane through the main chain of the polymer, e.g., the methyl groups are all above or below the plane. Using the Fischer projection formula, the stereochemical sequence of isotactic polypropylene is described as follows: 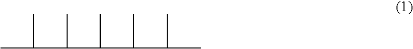
In Formula 1 each vertical segment indicates a methyl group on the same side of the polymer backbone. Another way of describing the structure is through the use of NMR. Bovey's NMR nomenclature for an isotactic pentad as shown above is . . . mmmm . . . with each “m” representing a “meso” dyad, or successive pairs of methyl groups on the same said of the plane of the polymer chain. As is known in the art, any deviation or inversion in the structure of the chain lowers the degree of isotacticity and crystallinity of the polymer.

In contrast to the isotactic structure, syndiotactic propylene polymers are those in which the methyl groups attached to the tertiary carbon atoms of successive monomeric units in the chain lie on alternate sides of the plane of the polymer. Syndiotactic polypropylene using the Fisher projection formula can be indicated by racemic dyads with the syndiotactic pentad rrrr shown as follows: 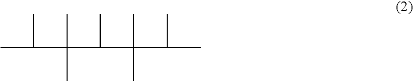
Here, the vertical segments again indicate methyl groups in the case of syndiotactic polypropylene, or other terminal groups, e.g. chloride, in the case of syndiotactic polyvinyl chloride, or phenyl groups in the case of syndiotactic polystyrene.

Other unsaturated hydrocarbons which can be polymerized or copolymerized with relatively short chain alpha olefins, such as ethylene and propylene include dienes, such as 1,3-butadiene or 1,4-hexadiene or acetylenically unsaturated compounds, such as methylacetylene.

### SUMMARY OF THE INVENTION

In accordance with the present invention, there are provided catalyst compositions and processes for the polymerization of ethylenically unsaturated monomers to produce polymers, including copolymers or homopolymers. Monomers, which are polymerized or copolymerized in accordance with the present invention, include ethylene, C₃₊ alpha olefins and substituted vinyl compounds, such as styrene and vinyl chloride. A particularly preferred application of the invention is in the polymerization of propylene including the homopolymerization of propylene to produce polypropylene, preferably isotactic polypropylene, and the copolymerization of ethylene and a C₃₊ alpha olefin to produce an ethylene alpha olefin copolymer, specifically an ethylene-propylene copolymer.

In carrying out the present invention, there is provided an olefin polymerization catalyst characterized by the formula:
B(FluA)MQₙ (3)
In formula (3), Flu is a fluorenyl group substituted at at least one of the 4 or 5 positions by a bulky hydrocarbyl group having at least 3 carbon atoms. A is a substituted or unsubstituted cyclopentadienyl or indenyl group or a heteroorgano group, XR, in which X is a heteroatom from Group 15 or 16 of the Periodic Table of Elements, and R is an organo group. Preferably X is nitrogen, phosphorus, oxygen or sulfur. More preferably, X will take the form of nitrogen. R is an alkyl group or cycloalkyl group containing from 1 to 20 carbon atoms, or a mononuclear aromatic group which may be substituted or unsubstituted. Further, with respect to formula (3), B is a structural bridge extending the groups A and Flu, which imparts stereorigidity to the ligand structure. Preferably, the bridge B is characterized by the formula ER′R″, in which E is a carbon, silicon or germanium atom, and R′ and R″ are each independently an alkyl group, an aromatic group or a cycloalkyl group. Further, with respect to formula (3), M is a Group 4 or Group 5 transition metal, preferably titanium, zirconium or hafnium. Q is selected from the group consisting of chlorine, bromine, iodine, an alkyl group, an amino group, an aromatic group and mixtures thereof. n is 1 or 2 and will have a value of 2 where the transition metal is zirconium, hafnium or titanium.

In one embodiment of the invention, the fluorenyl group is substituted at both of the 4 or 5 positions with a bulky hydrocarbyl group containing at least 3 carbon atoms. The bulky hydrocarbyl group may take the form of isopropyl groups or tetra-butyl groups or phenyl or substituted phenyl groups. Where the fluorenyl group is substituted at both the 4 and 5 positions, the group A is substituted or configured in order to provide asymmetry for the ligand structure extending through the bridge group and the transition metal atom. Thus, A may take the form of an indenyl group which is substituted or unsubstituted, or a cyclopentadienyl group which is substituted at the 3 or the 3 and 5 positions.

In a further embodiment of the invention, the fluorenyl group is mono-substituted at the 4 (or 5) position and is otherwise unsubstituted or is di-substituted at the 2,7 positions with alkyl or phenyl or substituted phenyl groups. In a further aspect of the invention, the fluorenyl group is substituted at the 4(5) position with a bulky substituent, specifically an isopropyl or a tetra-butyl group or a substituted or unsubstituted phenyl group and di-substituted at the 2,7 positions with substituents. In one embodiment of the invention, the substituents at the 2,7 position are of a lower molecular weight than the substituent at the 4(5) position. In another embodiment of the invention, the fluorenyl group, in addition to substitution at the 2,7 positions, is also di-substituted at the 3,6 position. The substituents at the 3,6 position may be the same as the substituents at the 2,7 position, but normally will be of a lower molecular weight than the substituents at the 2,7 position. When employing this embodiment of the invention, preferably the substituents at the 2,7 position are the same and the substituents at the 3,6 positions are the same. In a preferred embodiment of the invention, the ligand component A is a cyclopentadienyl group substituted at the 3 position with a tertiary butyl group and the fluorenyl group is substituted at the 4(5) position with a substituted or unsubstituted phenyl group. In a further embodiment of the invention, the cyclopentadienyl group is a also substituted at the 5 position with a methyl group.

In a further embodiment of the invention in which the olefin polymerization catalyst incorporates a substituted or unsubstituted cyclopentadienyl group and a substituted fluorenyl group, the catalyst component is characterized by the formula: 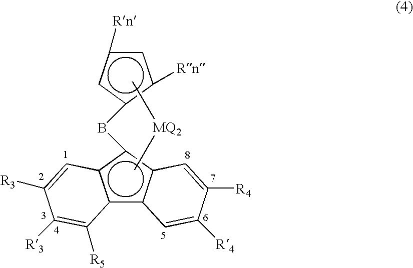
In formula (4), R′ is a C₁-C₄ alkyl group or an aryl group, R″ is a methyl group and n′ and n″ are each independently 0 or 1. B is a structural bridge between the fluorenyl and cyclopentadienyl groups and M is titanium, zirconium or hafnium. Q is as characterized above with respect to formula (3) and R₃ and R₄ are the same or different and are each a hydrogen or an isopropyl group, a tertiary butyl group, phenyl or substituted phenyl group. R₅ is an alkyl or aromatic group having a higher molecular weight than R₃ and R₄. R′₃ and R′₄ are each hydrogen or, where R₃ and R₄ are isopropyl or tertiary butyl groups, R′₃ and R′₄ may also be isopropyl groups or tertiary butyl groups. In a preferred embodiment of the invention, R′ in formula (4) is a tertiary butyl group, n′ is 1, R₃ and R₄ are each isopropyl or tertiary butyl groups and R₅ is a substituted or unsubstituted phenyl group. Preferably, n″ is 1. Thus, the cyclopentadienyl group is substituted at the 3 position with a tertiary butyl group and at the 5 position with a methyl group. In this embodiment of the invention, R₅ is preferably a 4-tertiary butyl phenyl group.

In yet a further embodiment of the invention in which the catalyst component is characterized by a bridged heteroatom-fluorenyl ligand structure, the olefin polymerization catalyst is characterized by the formula: 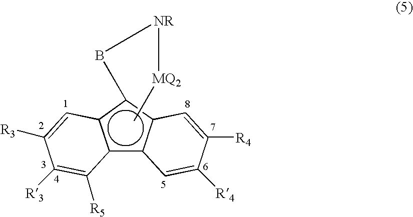
In formula (5), R is a mononuclear aromatic group or an alkyl group or cycloalkyl group containing from 1 to 20 carbon atoms. B is a structural bridge between the fluorenyl group and the heteroatom group NR, and M, Q, R₃ and R₄, R′₃, R′₄ and R₅ are as defined above with respect to formula (4).

In another embodiment of the invention, the olefin polymerization catalyst is characterized by the formula: 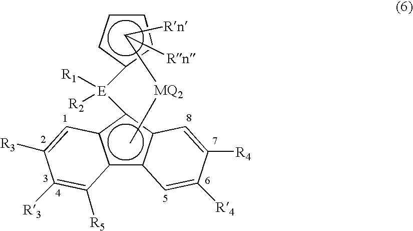
In formula (6), R′ is a C₁-C₄ alkyl group or an aryl group and n′ is from 0 (resulting in an unsubstituted cyclopentadienyl group when n″ is also 0) to 3 (resulting in a tri-substituted cyclopentadienyl group), R″ is an alkyl group of lower molecular weight than R′ and n″ is 0 or 1. E is —C— or —Si— extending between the fluorenyl and cyclopentadienyl groups and R₁ and R₂ are the same or different and are each a methyl group, a phenyl group or a substituted phenyl group. M is a titanium, zirconium or hafnium atom, and Q is a chlorine, methyl group or phenyl group. R₃ and R₄ are the same or different are each a hydrogen or a C₁-C₄ alkyl group, phenyl or substituted phenyl group, and R₅ is an alkyl group or an aromatic group which has a higher molecular weight than R₃ or R₄. R′₃ and R′₄ are the same or different and are a hydrogen or a C₁-C₄ alkyl group, provided that when R₃ and R₄ are hydrogen, R′₃ and R′₄ are also hydrogen. Where R₃ and R₄ are alkyl groups, R′₃ and R′₄ may be hydrogen or alkyl groups with R′₃ and R′₄ preferably having a molecular weight which is less than the molecular weight of R₃ and R₄. Preferably, R₅ is tertiary butyl group, a phenyl group or a 4-tertiary butyl group.

In a further embodiment of the present invention, there are provided processes for the polymerization of one or more ethylenically unsaturated monomers to produce a corresponding homopolymer or copolymer. In carrying out the polymerization process of the present invention, there is provided a transition metal catalyst as characterized by the above formulas (3), (4), (5) and (6). In addition to the transition metal catalyst component, there is provided an activating co-catalyst component such as an alumoxane. The catalyst component and the co-catalyst component are contacted in a polymerization reaction zone with an ethylenically unsaturated monomer under polymerization conditions to produce a polymer product which is then recovered from the reaction zone. Preferably, the activating co-catalyst comprises methylalumoxane (MAO) or tri-isobutylalumoxane (TIBAO) or mixtures thereof. Alternatively, the activating co-catalyst can take the form of a noncoordinating anionic type, such as triphenylcarbenium tetrakis(pentafluorophenyl)aluminate or triphenylcarbenium tetrakis(pentafluorophenyl)boronate. Preferably, the ethylenically unsaturated monomer is a C₃₊ alpha olefin. More specifically, the alpha olefin is propylene and the polymerization reaction is carried out to produce isotactic polypropylene.

### DETAILED DESCRIPTION OF INVENTION

The present invention involves bridged transition metal catalysts having and their use in the polymerization of olefins. Specific olefins which may be polymerized, either through homopolymerization or copolymerization include ethylene, propylene, butylene, as well as monoaromatic or substituted vinyl compounds as described previously. The bridged catalyst components of the present invention incorporate transition metals from Groups 4 or 5 of the Periodic Table of Elements (new notation) and more particularly, transition metals from Group 4 of the Periodic Table of Elements. Preferred transition metals for use in the catalyst components of the present invention are titanium, zirconium and hafnium, with zirconium being particularly preferred.

The catalyst components of the present invention incorporate substituted fluorenyl groups which are bridged to substituted or unsubstituted cyclopentadienyl or indenyl groups or heteroorgano groups and are substituted in a manner to provide ligand structures which are unbalanced with respect to a plane of symmetry through the bridge and the transition metal. More specifically, catalyst components of the present invention comprise metallocene ligand structures which incorporate substituted fluorenyl groups which are bridged to substituted or unsubstituted cyclopentadienyl or indenyl groups or heteroorgano groups and which are substituted in a manner in which the ligand structures are asymmetric with a plane of symmetry extending through the bridge and the transition metal.

The following diagrams indicate metallocene ligand structures (and the numbering schemes for such structures) which may be employed in carrying out the present invention. Diagram (7) indicates a cyclopentadienyl-fluorenyl ligand structure, diagram (8 an indenyl-fluorenyl ligand structure and diagram (9) a heteroatom (XR)-fluorenyl ligand structure. 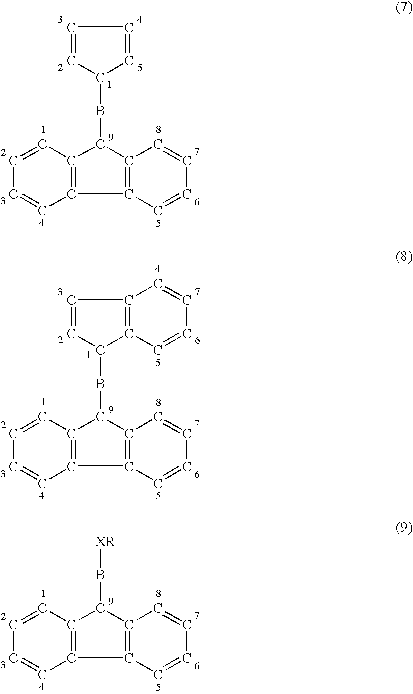
The numbering schemes used to indicate the position of substituents on the various ligand structures are indicated on diagrams (7), (8) and (9). With respect to structure (8), while not shown, the indenyl moiety may take the form of 4,5,6,7-tetrahydro indenyl as well as the more common unhydrogenated indenyl group. For each of diagrams (7), (8) and (9), the metallocene ligand structures may be characterized in terms of a plane of symmetry extending perpendicular to the plane of the paper through the bridge group B and the transition metal (not shown) in diagrams (7), (8) and (9) which would project upwardly from the plane of the paper.

As described with respect to the various examples below and with respect to diagram (7), the cyclopentadienyl group may be unsubstituted and the fluorenyl group may be substituted at the 4 position with a relatively bulky isoalkyl group, specifically a tertiary butyl group, or a phenyl group which may be substituted or unsubstituted. If there are no other substituents or if the cyclopentadienyl group or fluorenyl group are otherwise symmetrically substituted, the 4 position is equivalent to the 5 position on the fluorenyl group and this relationship is expressed by the positional expression 4(5).

The present invention involves bridged transition metal catalysts having the fluorenyl ligand with bulkier substituent at least at the 4-(5-) fluorenyl position and their use in the polymerization of olefins. The bulkier groups at the 4- and 5-positions of fluorenyl ligand described in the invention provide specific features of the catalysts, especially in alpha-olefin polymerization such as propylene polymerization. The catalyst precursors of the present invention are represented by the formula: 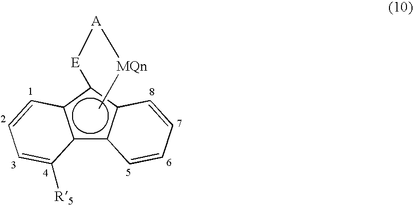
wherein the fluorenyl ligand is substituted with at least one bulky group (at least three carbon atoms) at the 4- or 5-position; R′₅ is a bulky substituent. That is, the sterically hindering group can be selected from alkyl (preferably branched), alkenyl (preferably branched), cycloalkyl, heterocyclic, alkylaryl and aryl, containing from 3 to 30 carbon atoms. A, B, M, Q and n are as described previously with respect to formula 3.

Non-limiting examples of fluorenyl ligands include: 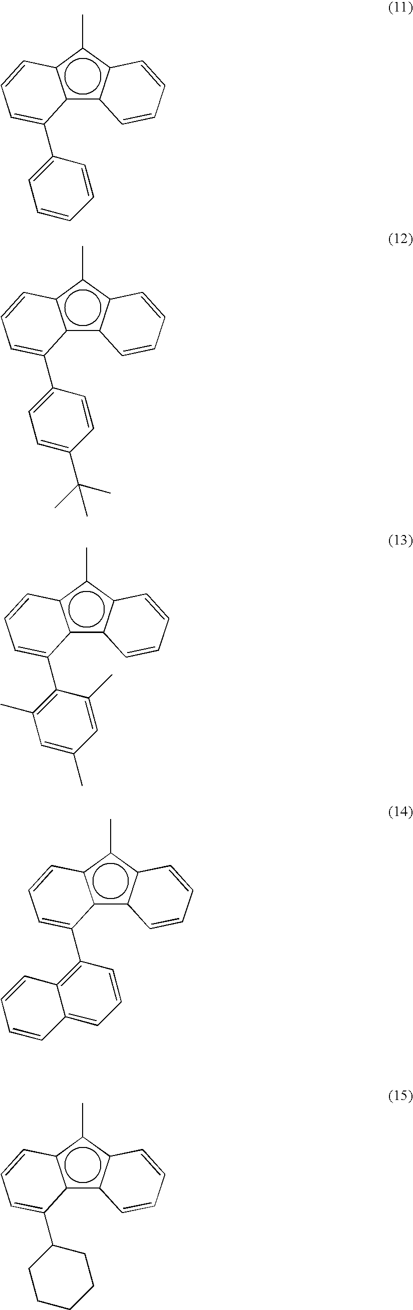 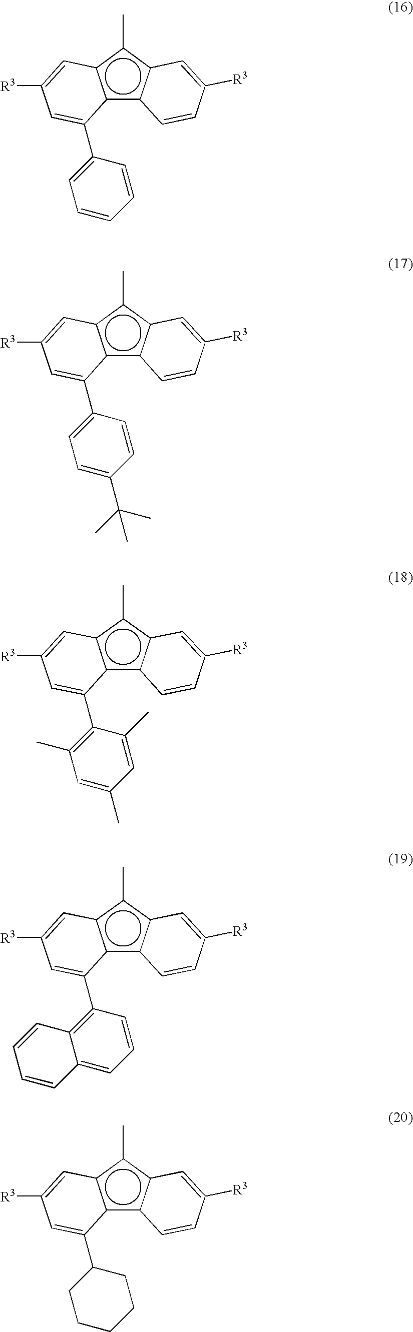 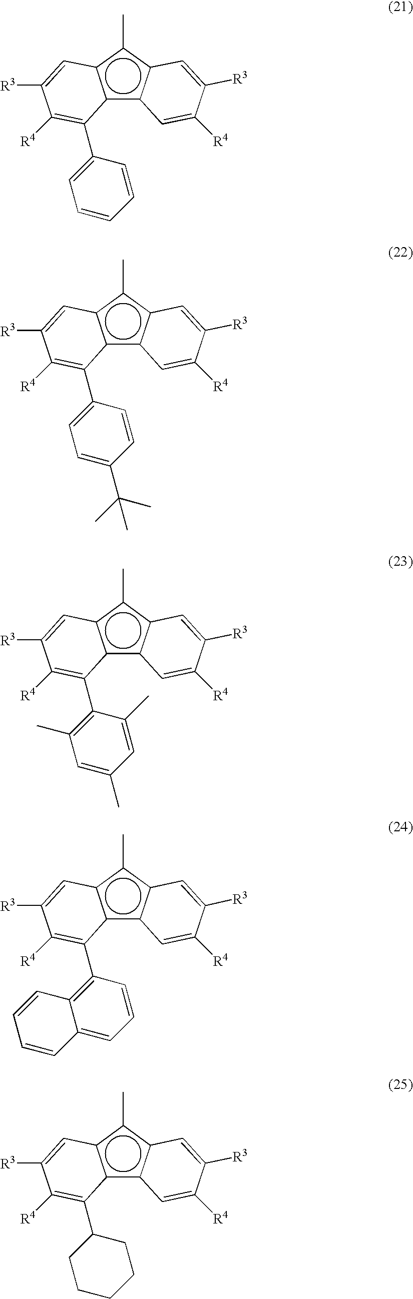
R³, R⁴, R⁵, R⁶ are each an alkyl or aryl.

The catalysts of the present invention can be advantageously used in propylene polymerization to produce isotactic polypropylene with high yield, having high molecular weight, high tacticity and high melt temperature. Desired features of the catalysts of the present invention are due to a unique combination of structure parameters of the catalysts, substitutes at the cyclopentadienyl and fluorenyl rings, and a presence of two stereoisomers, each of them produces isotactic polymers. In addition, the catalysts of the present invention can be used in copolymerization of propylene with olefins, e.g. ethylene to yield random or impact copolymers.

Ligand structures suitable for use in carrying out the present invention which can be employed to produce isotactic polypropylene include, with reference to diagram (7), 3-tertiary butyl, 5-methyl cyclopentadienyl, 2,7-ditertiary butyl, 4-phenyl fluorene, the same ligand structure except with substitution on the fluorenyl structure at the 5 position and the same ligand structure with substitution at the 4 or 5 position by a 4-tertiary butyl phenyl group. In other words, the phenyl group is substituted by a tertiary butyl group at the directly distal position with respect to the substitution of the phenyl group on the fluorenyl group.

Other suitable ligand structures which can be employed to produce isotactic polypropylene include ligand structures such as described above, except the cyclopentadienyl group is mono-substituted at the 3 position with a tertiary butyl group. The fluorenyl group is substituted as before at the 2 and 7 position with the tertiary butyl groups and at the 4 position with a phenyl group or a 4-tertiary butyl phenyl group.

Similarly substituted ligand structures may be employed in accordance with the present invention incorporate a bis-indenyl fluorenyl ligand structure exemplified by diagram (8). Typically, because of the unbalanced characteristic of the indenyl structure, further substitution of the indenyl (or the 4,5,6,7-tetrahyrdo indenyl) group will not be employed. The fluorenyl ligand component may be substituted as described previously, thus, it may be substituted at the 4 position or di-substituted at the 4 and 5 position with bulky groups, such as tertiary butyl and phenyl groups. Also, the fluorenyl ligand structure may be substituted at one of the 4 and 5 positions and di-substituted at the 2 and 7 positions with substituent groups, which are less bulky than the substituents on the 4 or 5 position.

The heteroatom ligand structure depicted in diagram (9) may be substituted on the fluorenyl group similarly as described above with respect to diagrams (7) and (8). Thus, for example, the fluorenyl group may be substituted at the 2 and 7 positions with tertiary butyl groups and substituted at the 4 position with a substituted or unsubstituted phenyl group. Alternatively, the fluorenyl group may be unsubstituted at the 2 and 7 positions and substituted at the 4 position with an isopropyl group, a tert-butyl group, a phenyl group or a substituted phenyl group.

In employing the catalyst components of the present invention in polymerization procedures, they are used in conjunction with an activating co-catalyst. Suitable activating co-catalysts may take the form of co-catalysts such are commonly employed in metallocene-catalyzed polymerization reactions. Thus, the activating co-catalyst may take the form of an aluminum co-catalyst. Alumoxane co-catalysts are also referred to as aluminoxane or polyhydrocarbyl aluminum oxides. Such compounds include oligomeric or polymeric compounds having repeating units of the formula: 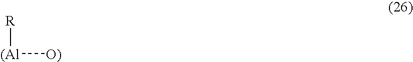
where R is an alkyl group generally having 1 to 5 carbon atoms. Alumoxanes are well known in the art and are generally prepared by reacting an organo-aluminum compound with water, although other synthetic routes are known to those skilled in the art. Alumoxanes may be either linear polymers or they may be cyclic, as disclosed for example in U.S. Pat. No. 4,404,344. Thus, alumoxane is an oligomeric or polymeric aluminum oxy compound containing chains of alternating aluminum and oxygen atoms whereby the aluminum carries a substituent, preferably an alkyl group. The structure of linear and cyclic alumoxanes is generally believed to be represented by the general formula —(Al(R)—O—)-m for a cyclic alumoxane, and R₂Al—O—(Al(R)—O)m-AlR₂ for a linear compound wherein R independently each occurrence is a C₁-C₁₀ hydrocarbyl, preferably alkyl or halide and m is an integer ranging from 1 to about 50, preferably at least about 4. Alumoxanes also exist in the configuration of cage or cluster compounds. Alumoxanes are typically the reaction products of water and an aluminum alkyl, which in addition to an alkyl group may contain halide or alkoxide groups. Reacting several different aluminum alkyl compounds, such as, for example, trimethylaluminum and tri-isobutylaluminum, with water yields so-called modified or mixed alumoxanes. Preferred alumoxanes are methylalumoxane and methylalumoxane modified with minor amounts of other higher alkyl groups such as isobutyl. Alumoxanes generally contain minor to substantial amounts of the starting aluminum alkyl compounds. The preferred co-catalyst, prepared either from trimethylaluminum or tri-isobutylaluminum, is sometimes referred to as poly(methylaluminum oxide) and poly(isobutylaluminum oxide), respectively.

The alkyl alumoxane co-catalyst and transition metal catalyst component are employed in any suitable amounts to provide an olefin polymerization catalyst. Suitable aluminum transition metal mole ratios are within the range of 10:1 to 20,000:1 and preferably within the range of 100:1 to 5,000:1. Normally, the transition metal catalyst component and the alumoxane, or other activating co-catalyst as described below, are mixed prior to introduction in the polymerization reactor in a mode of operation such as described in U.S. Pat. No. 4,767,735 to Ewen et al. The polymerization process may be carried out in either a batch-type, continuous or semi-continuous procedure, but preferably polymerization of the olefin monomer (or monomers) will be carried out in a loop type reactor of the type disclosed in the aforementioned U.S. Pat. No. 4,767,735. Typical loop type reactors include single loop reactors or so-called double loop reactors in which the polymerization procedure is carried in two sequentially connected loop reactors. As described in the Ewen et al. patent, when the catalyst components are formulated together, they may be supplied to a linear tubular pre-polymerization reactor where they are contacted for a relatively short time with the pre-polymerization monomer (or monomers) prior to being introduced into the main loop type reactors. Suitable contact times for mixtures of the various catalyst components prior to introduction into the main reactor may be within the range of a few seconds to 2 days. For a further description of suitable continuous polymerization processes which may be employed in carrying out the present invention, reference is made to the aforementioned U.S. Pat. No. 4,767,735, the entire disclosure of which is incorporated herein by reference.

Other suitable activating co-catalysts which can be used in carrying out the invention include those catalysts which function to form a catalyst cation with an anion comprising one or more boron atoms. By way of example, the activating co-catalyst may take the form of triphenylcarbenium tetrakis(pentafluorophenyl) boronate as disclosed in U.S. Pat. No. 5,155,080 to Elder et al. As described there, the activating co-catalyst produces an anion which functions as a stabilizing anion in a transition metal catalyst system. Suitable noncoordinating anions include [W(PhF₅)]⁻, [Mo(PhF₅)]⁻ (wherein PhF₅ is pentafluorophenyl), [ClO₄]⁻, [S₂O₆]⁻, [PF₆]⁻, [SbR₆]⁻, [AlR₄]⁻ (wherein each R is independently Cl, a C₁-C₅ alkyl group preferably a methyl group, an aryl group, e.g. a phenyl or substituted phenyl group, or a fluorinated aryl group). Following the procedure described in the Elder et al. patent, triphenylcarbenium tetrakis(pentafluorophenyl)boronate may be reacted with pyridinyl-linked bis-amino ligand of the present invention in a solvent, such as toluene, to produce a coordinating cationic-anionic complex. For a further description of such activating co-catalyst, reference is made to the aforementioned U.S. Pat. No. 5,155,080, the entire disclosure of which is incorporated herein by reference.

In addition to the use of an activating co-catalyst, the polymerization reaction may be carried out in the presence of a scavenging agent or polymerization co-catalyst which is added to the polymerization reactor along with the catalyst component and activating co-catalyst. These scavengers can be generally characterized as organometallic compounds of metals of Groups 1A, 2A, and 3B of the Periodic Table of Elements. As a practical matter, organoaluminum compounds are normally used as co-catalysts in polymerization reactions. Specific examples include triethylaluminum, tri-isobutylaluminum, diethylaluminum chloride, diethylaluminum hydride and the like. Scavenging co-catalysts normally employed in the invention include methylalumoxane (MAO), triethylaluminum (TEAL) and tri-isobutylaluminum (TIBAL).

The bridged fluorenyl ligand structures and the corresponding transition metal catalyst components can be prepared by any suitable techniques. Typically, for methylene bridged cyclopentadienyl fluorenyl ligand structures, the fluorenyl group is treated with methyl lithium to result in a fluorenyl group substituted with lithium in the 9 position and this is then reacted with a 6,6 substituted fulvene. For example, 6,6-dimethyl fulvene may be employed to produce the isopropylidene cyclopentadienyl substituted fluorenyl ligand structure. For a ligand structure in which E is a germanium or silicon atom, the lithiumated fluorenyl group is reacted, for example, with diphenylsilyl dichloride to produce the diphenylsilyl chloride substituent at the 9 position on the fluorenyl group. This component is then reacted with the lithiumated cyclopentadienyl or substituted cyclopentadienyl to produce the bridge. The ligand structure is then treated with methyl lithium, followed by reaction with the appropriate transition metal, chlorine, e.g. zirconium tetrachloride, to produce the corresponding metallocene dichloride.

The preparation of the bridged cyclopentadienyl fluorenyl ligand structure characterized by formula (6) 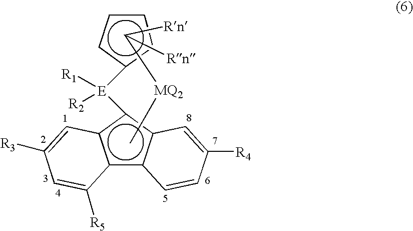
in which R₃ and R₄ are the same and are hydrogen or a tert-butyl group and R₅ is a bulky alkyl group or an aryl group, e.g. a phenyl group or a tertiary butyl phenyl group, may be generally characterized by the following sequence:

Main steps of the ligand preparation:

### 1. Protection of the 2, and 7-positions of fluorenyl ligand

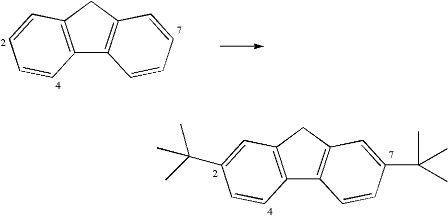

In step one, the fluorine reacts with 2,6-di-tertbutyl-4-methylphenol in the presence of aluminum chloride to give 2,7-di-tert-butyl-fluorene.

### 2. Bromination of 2,7-di-tert-butyl-fluorene

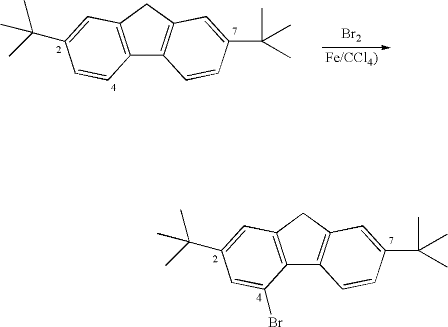

In step two, the 2,7-di-tert-butyl fluorene selectively reacts with bromine in the presence of an iron catalyst to produce 4-bromo-2,7-di-tert-butyl-fluorene.

### 3. Coupling reaction: attachment of a 4-fluorenyl substituent

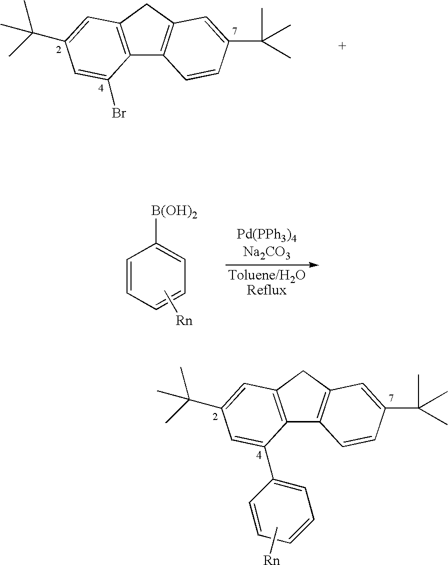

In step three of the method, 4-bromo-2,7-di-tert-butyl-fluorene is reacted with aryl boronic acid in the presence of palladium catalyst to form 4-aryl-2,7-di-tert-butyl-fluorene. In another method, 4-iodo-2,7-di-tert-butyl-fluorene is reacted with alkyl Grignard reagent to give corresponding 4-alkyl-2,7-di-tert-butyl-fluorene. A variety of aryl boronic acids and Grignard reagents allow the attachment of different substituents at the 4-position of fluorene.

### 4. Synthesis of Bridged Ligand

In step four, the bridged ligand is synthesized by using 4-substituted fluorene. In one method, the 4-substitued fluorene is deprotonated by reacting with it at least one equivalent of methyllithium or butyllithium. The resulting anion is reacted with fulvene to produce the bridged ligand.

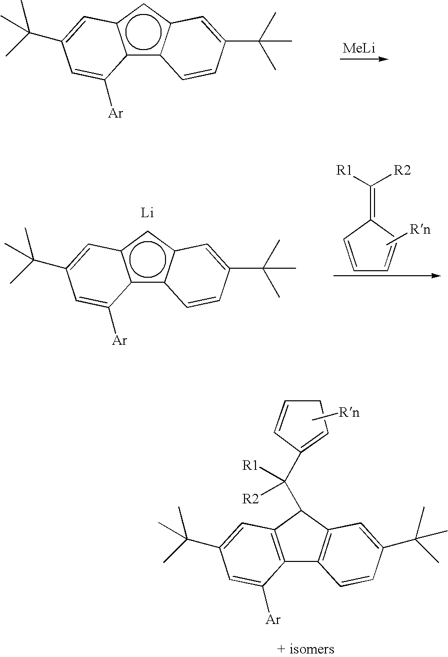

In another method, the lithium salt of 4-substituted fluorene is reacted with dichlorosilane. The silicon-fluorenyl compound is then reacted with either cyclopentadienyl lithium, indenyl lithium or lithium amide:

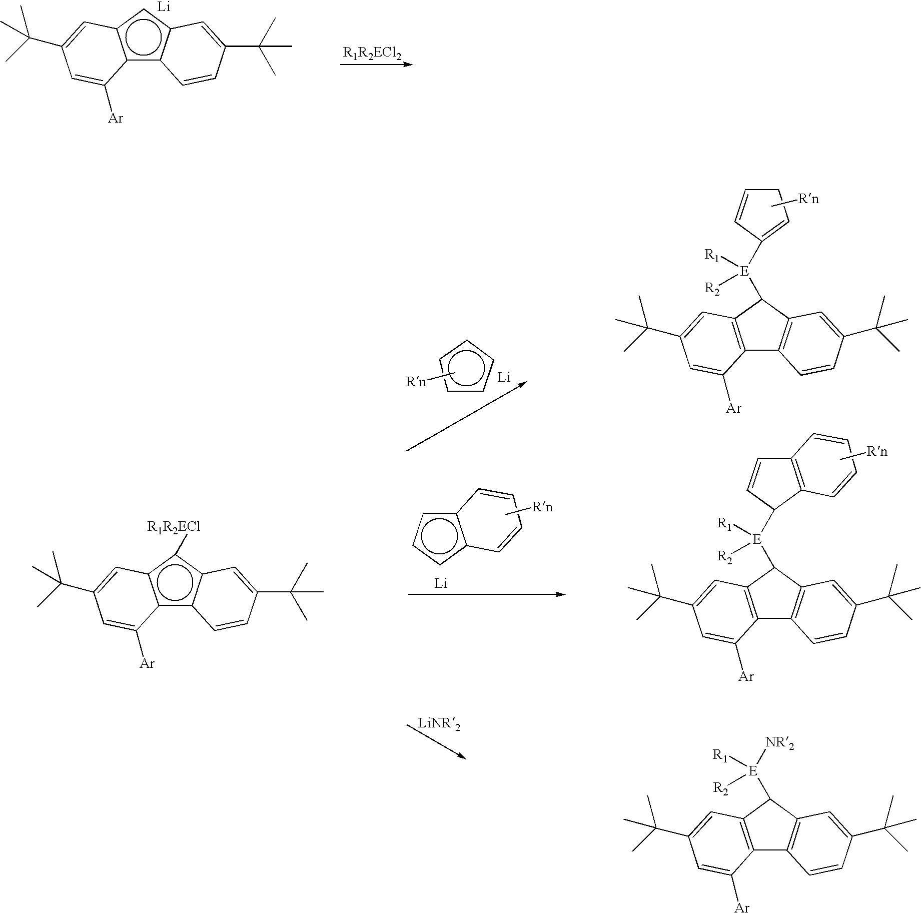

The ligands produced by reactions according to the present invention are prepared by means of a very simple and efficient process, which employs inexpensive starting materials and comprises single reaction steps having high yields. Furthermore, this process does not require laborious and time-consuming purification procedures, and thus is particularly suitable to large-scale production.

The metallocene complexes can be prepared by reaction of corresponding lithium salts with MClₙ(M=Ti, Zr, Hf, V, n=3,4), e.g.:

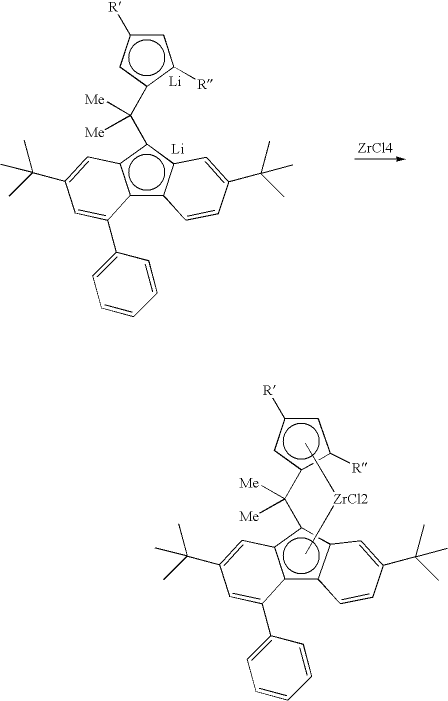

The following examples are illustrative of the preparation of certain metallocenes embodying the present invention and their use in the polymerization of propylene.

### EXAMPLE 1

### Synthesis of 4-Bromo-2,7-di-t-butylfluorene

To a mixture of 2,7-di-t-butylfluorene (5.95 g, 21.4 mmol) and catalytic amount of iron powder in CCl₄ (40 ml) was added a solution of bromine (3.9 g, 24.3 mmol) in CCl₄ (10 ml) at 0° C. The reaction mixture was stirred for more than 3 hours at room temperature and then was quenched with water. The mixture was extracted with ether, and the ether solution was washed with 10% NaOH solution, dried over MgSO₄, and evaporated under vacuum to afford the residue which was recrystallized from hot ethanol to give 4-bromo-2,7-di-t-butylfluorene (6.7 g, 87.6%). ¹H NMR (CDCl₃): δ 8.44 (d, 1H, J=8.4, H5), 7.6-7.4 (m, 4H, H1, H3, H6 and H8), 3.89 (s, 2H, H9), 1.38, 1.36 (each s, 9H, t-Bu).

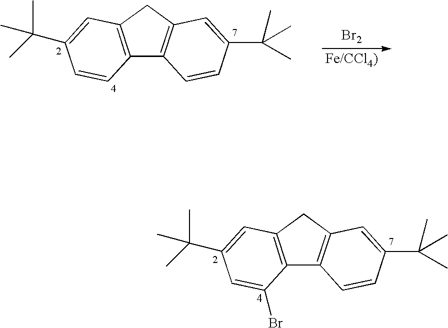

### EXAMPLE 2

### Synthesis of 4-Bromo-fluorene

4-Bromo-2,7-di-t-butylfluorene (5.0 mmol) from Example 1 and AlCl₃ (0.5 mmol) in benzene (50 ml) was heated at 50° C. for 6 hours. The mixture was quenched with water, then the organic layer was extracted with ether and dried with MgSO₄. The solvent was removed under vacuum. The residue was pumped under vacuum at 100° C. to give 4-bromo-fluorene.

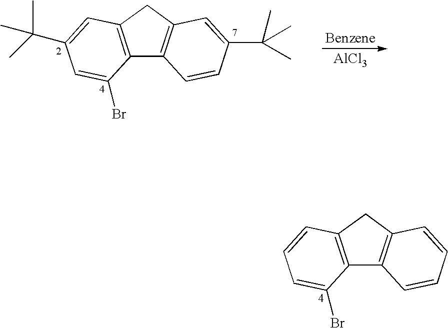

### EXAMPLE 3

### Synthesis of 4-Phenyl-2,7-di-t-butylfluorene

To a mixture of 4-bromo-2,7-di-t-butylfluorene (3.10 g, 8.68 mmol) and Pd(PPh₃)₄ (700 mg) in toluene (100 ml) was added a solution of phenylboronic acid (1.59 g) in EtOH (20 ml) and a solution of Na₂CO₃ (2.9 g) in water (15 ml). The reaction mixture was stirred for 3 hours under reflux. The reaction mixture was quenched with water, extracted with ether, dried over MgSO₄, and evaporated under vacuum to afford the residue which was purified by column chromatography (silica gel, hexane) to give 4-phenyl-2,7-di-t-butylfluorene (2.50 g, 81%). ¹H NMR (CD₂Cl₂): δ 7.60, 7.57 and 7.24 (d or br s, H1, H3, and H8), 7.48 (m, 5H, Ph), 7.03 (dd, 1H, J=8.1 Hz, J=1.5 Hz, H6), 6.86 (d, 1H, J=8.1 Hz, H5), 3.93 (s, 2H, H9), 1.41 and 1.33 (each s, 9H, t-Bu).

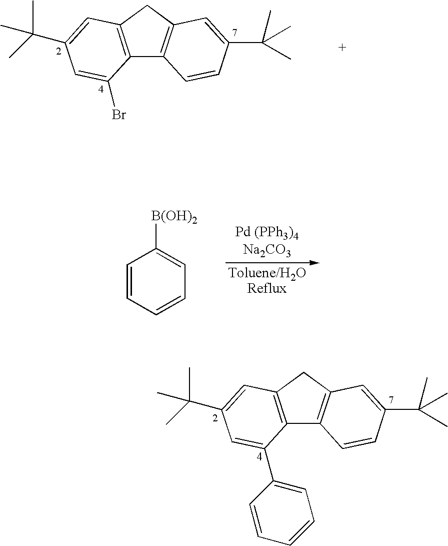

### EXAMPLE 4

### Synthesis of 4-Phenyl-fluorene

The same procedure as in Example 2 was repeated except that reaction was conducted by using 4-bromo-butylfluorene.

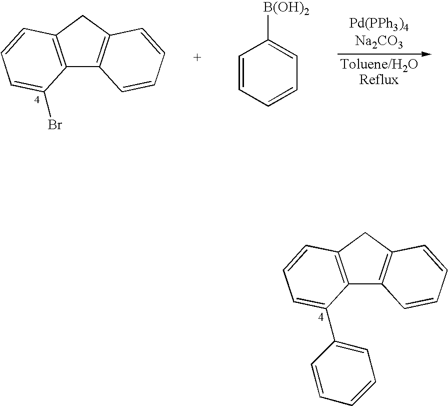

### EXAMPLE 5

### Synthesis of 4-(4-tert-Butylphenyl)-2,7-di-t-butylfluorene

To a mixture of 4-bromo-2,7-di-t-butylfluorene (1.34 g, 3.75 mmol) and Pd(PPh₃)₄ (300 mg, 0.26 mmol) in toluene (50 ml) was added a solution of 4-tert-butylphenylboronic acid (1.00 g, 5.62 mmol) in EtOH (10 ml) and a solution of Na₂CO₃ (1.19 g) in water (15 ml). The reaction mixture was stirred for 20 hours under reflux. The reaction mixture was quenched with water, extracted with ether, dried over MgSO₄, and evaporated under vacuum to afford the residue which was purified by column chromatography (silica gel, hexane/CH₂Cl₂=5:1) to give 4-phenyl-2,7-di-t-butylfluorene (1.50 g, 97%). ¹H NMR (CD₂Cl₂): δ 7.7-7.4 (m, 6H, Harom), 7.23 (d,1H, J=1.5 Hz), 7.10 (dd, 1H, J=8.4 Hz, J=1.5 Hz, H6), 6.93 (d, 1H, J=8.4 Hz, H5), 3.92 (s, 2H, H9), 1.44. 1.40 and 1.33 (each s, 27H, t-Bu).

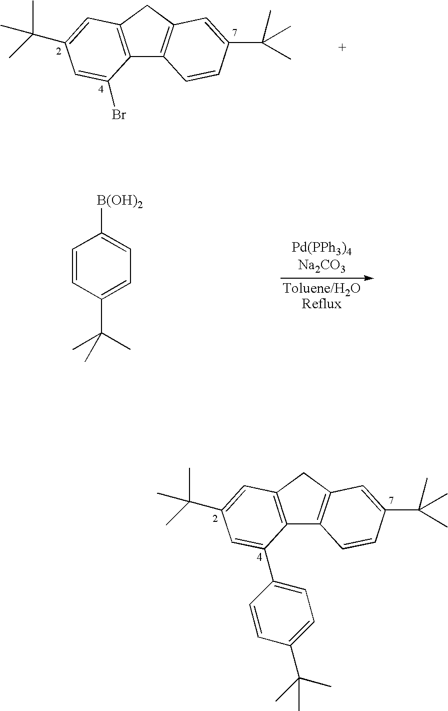

### EXAMPLE 6

### Synthesis of 2,2-[(Cyclopentadienyl)-[(4-phenyl-2,7-di-tert-butylfluorenyl)]-propane

Methyllithium (1.9 ml, 1.6M in Et₂O, 3.04 mmol) was added to 4-phenyl-2,7-di-t-butylfluorene (1.00 g, 2.82 mmol) in THF (20 ml) at −78° C. The reaction mixture was allowed to warm to room temperature and stirred for 4 hours. 6,6′-Dimethylfulvene (0.300 g, 2.83 mmol) was added to the reaction mixture at 0° C. The reaction was stirred at room temperature overnight. The reaction was quenched by water and the organic phase was extracted with ether and dried under MgSO₄. The solvent was evaporated under vacuum to afford the residue, which was purified by column chromatography (silica gel, hexane and hexane/CH₂Cl₂=6/1) to give the desired ligand (0.67 g, 52%). ¹H NMR (CD₂Cl₂): δ 7.46 (m, 5H, Ph), 7.24 (d, 1H, J=8.4 Hz, Flu), 7.20-6.90 (4H, Flu), 6.8-5.9 (4H, Cp)), 4.15 and 4.10 (s, 1H, H9 Flu), 3.20 and 3.09 (br s, 2H, Cp), 1.30 and 1.23 (each s, 9H, t-Bu, Flu), 1.12 and 1.10 (6H, Me-bridge).

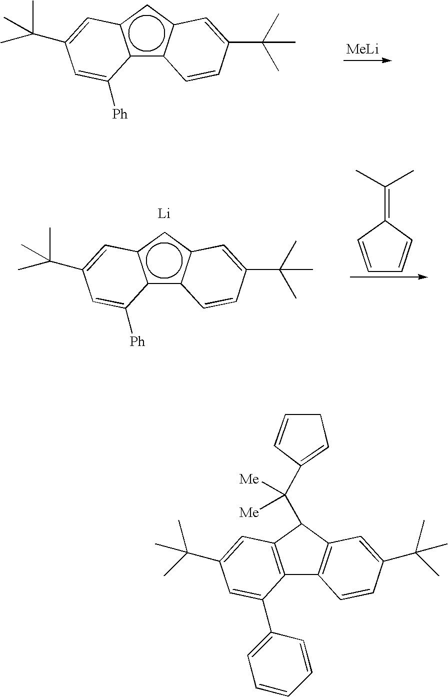

### EXAMPLE 7

### [Cyclolpentadienyl)(4-phenyl-2,7-di-tert-butylfluorenyl)propane]zirconium dichloride (Catalyst 1)

Methyllithium (1.7 ml, 1.6M, 2.72 mmol) was added to 2,2-[(cyclopentadienyl)-[(4-phenyl-2,7-di-tert-butylfluorenyl)]-propane (0.61 g, 1.32 mmol) in THF (20 ml) at −78° C. The reaction mixture was brought to room temperature and the reaction was continued for 6.5 hours. The solvent was removed under vacuum. ZrCl₄ (307 mg, 1.32 mmol) was added to the reaction mixture. Hexane (20 ml) was added and the reaction was stirred at room temperature overnight. The solvent was removed under vacuum. Toluene (30 ml) was added and the solution was filtered. Toluene was removed under vacuum. ¹H NMR (C₆D₆): δ 7.6-6.9 (Ph, Flu), 6.11 (br s (m) 2H Cp), 5.82 (dd, 2H, J=6.9 Hz, J=1.5 Hz, Cp), 1.35 and 1.27 (each s, 9H, t-Bu, Flu), 1.31 (s, 6H, Me-bridge).

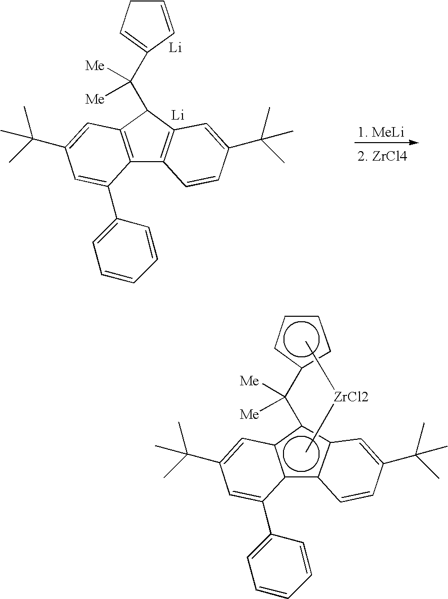

### EXAMPLE 8

### Synthesis of 2,2-[(Cyclopentadienyl)-[(4-(4-tert-butylphenyl -2,7-di-tert-butylfluorenyl)]-propane

The same procedure as in Example 6 was repeated except that reaction was conducted by using 4-(4-tert-butylphenyl)-2,7-di-t-butylfluorene.

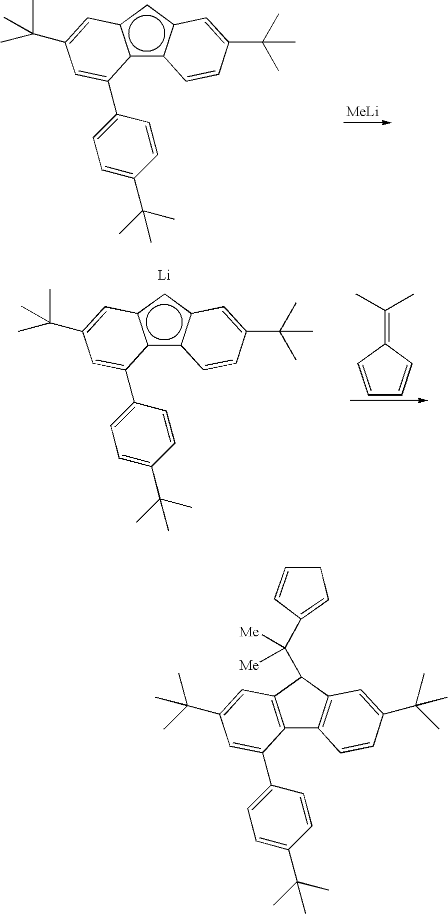

### EXAMPLE 9

### [Cyclopentadienyl)(4-(4-tert-butyl)phenyl-2,7-di-tert-butylfluorenyl)propane]zirconium dichloride (Catalyst 2)

The same procedure as in Example 7 was repeated except that reaction was conducted by using the ligand from Example 8.

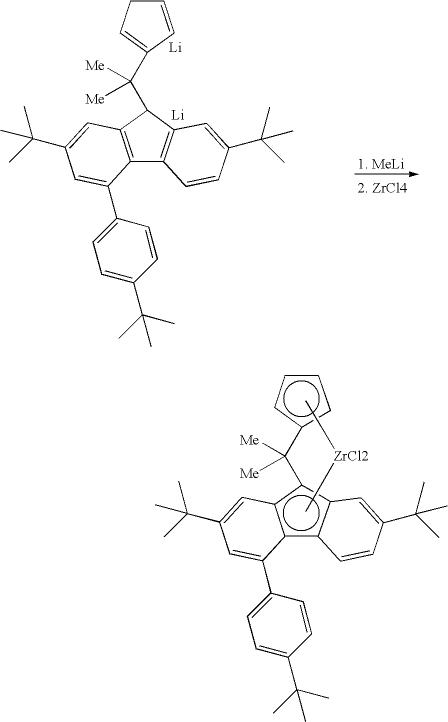

### EXAMPLE 10

### 2,2-[(3-tert-Cyclopentadienyl)-[(4-phenyl-2,7-di-tert-butylfluorenyl)]-propane 10(1) 6,6′-Dimethyl-3-tert-butylfulvene

Pyrrolidine (19.0 ml, 0.225 mol) was added to a solution of tert-butyl-cyclopentadiene (20.4 g, 0.15 mol) in methanol (200 ml) and acetone (16.5 ml, 0.225 mol). The reaction mixture was stirred overnight. The reaction was quenched by water and the organic phase was extracted with ether and dried under MgSO₄. The solvent was evaporated under vacuum to afford the residue, which was distilled under vacuum 75° C./4-5 mbar). ¹H NMR (CDCl₃): δ 6.56 (br s, 2H, Cp), 6.19 (br s, 1H, Cp), 2.19 (s, 6H, Me-6,6′), 1.25 (s, 9H, t-Bu).

### 10(2)

Methyllithium (2.3 ml, 1.6M in Et₂O, 3.68 mmol) was added to 4-phenyl-2,7-di-t-butylfluorene (1.26 g, 3.56 mmol) in THF (20 ml) at −78° C. The reaction mixture was broght to room temperature and stirred for 3 hours. 6,6′-Dmethyl-3-tert-butylfulvene (0.578 g, 3.56 mmol) was added to the reaction mixture. The reaction was stirred at room temperature overnight. The reaction was quenched by water and the organic phase was extracted with ether and dried under MgSO₄. The solvent was evaporated under vacuum to afford the residue, which was purified by column chromatography (silica gel, hexane) to give the desired ligand (0.70 g).

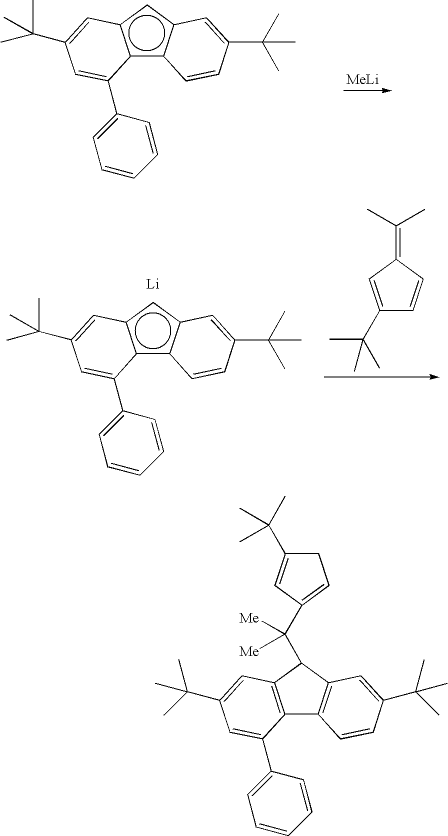

### EXAMPLE 11

### 2.2-[(3 -tert-Cyclopentadienyl)-[(4-phenyl-2,7-di-tert-butylfluorenyl)]-propane]zirconium dichloride (Catalyst 3)

The same procedure as in Example 7 was repeated except that reaction was conducted by using the ligand from Example 10.

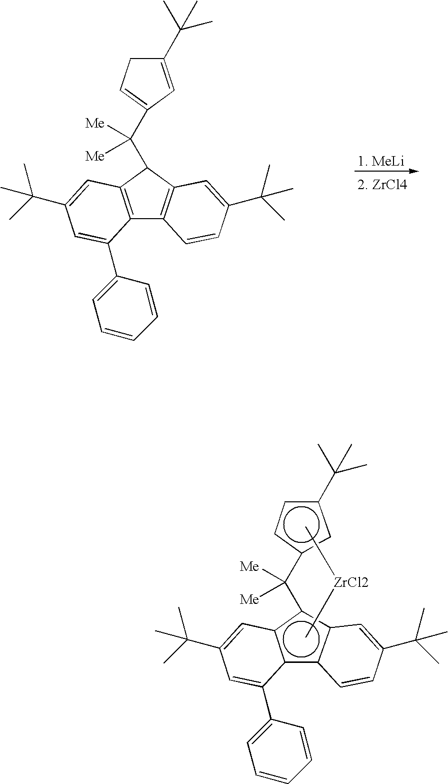

### EXAMPLE 12

### 2,2-[(3-tert-butyl-5-methyl-cyclopentadienyl)-[(4-phenyl-2,7-di-tert-butylfluorenyl)1-propane

### 12(1) 1-Methyl-3-tert-butyl-cyclopentadiene

200 ml of Tert-butyllithium (0.34 mmol, 1.7 mol in was placed in a 1 L flask. To this solution was added 100 ml of ether at 0° C. Subsequently, a solution containing 21.33 g (0.227 mol) of 3-methyl-2-cyclopentanone in 50 ml of ether was added. The reaction mixture was stirred at ambient temperature for 24 hours. The brown mixture was transferred in a 1:1 ratio of solution (50/50) of NH₄Cl saturated and ice. The orange solution was extracted with ether. After extraction, the yellow organic phase was dried under MgSO₄ and after filtration was evaporated. The remaining yellow oil was purified by distillation (65° C./3.9 mbar), (the yield: 6.0 g).

### 12(2) 1,6,6′-Trimethyl-3-tert-butylfulvene

Pyrrolidine (15.0 ml, 0.18 mol) was added to a solution of 1-methyl-3-tert-butyl-cyclopentadiene (5.8 g, 46.8 mmol) in methanol (40 ml) and acetone (7.9 g, 0.136 mol). The reaction mixture was stirred for 4 days. The reaction was quenched by water and the organic phase was extracted with ether and dried under MgSO₄. The solvent was evaporated under vacuum to afford the residue, which was purified by column chromatography (silica gel, hexane) to give the ligand (6.0 g). ¹H NMR (CDCl₃): δ 6.22 and 6.03 (both m, 1H, Cp), 2.22 (d, 3H, J=1.2 Hz, CH₃-1), 2.17 and 2.16 (s, 6H, Me-6,6′), 1.16 (s, 9H, t-Bu).

### 12(3)

Methyllithium (1.3 ml, 1.6M in Et₂O, 2.08 mmol) was added to 4-phenyl-2,7-di-t-butylfluorene (0.71 g, 2.00 mmol) in THF (20 ml) at −78° C. The reaction mixture was brought to room temperature and stirred for 3 hours. 1,6,6′-Trimethyl-3-tert-butylfulvene (0.36 g, 2.08 mmol) was added to the reaction mixture. The reaction was stirred at room temperature for 3 hours. The solvent was evaporated under vacuum to afford the residue, which was purified by column chromatography (silica gel, hexane) to give the ligand (0.97 g, 91%). ¹H NMR (CD₂Cl₂): δ 7.4-7.2 (br s, 2H, H1 and H8 Flu), 7.46 (m, 5H, Ph), 7.16 (d, 1H, J=1.5 Hz, H3 (Flu)), 6.99 (dd, 1H, J=8.4 Hz, J=1.5 Hz, H6, Flu), 6.70 (d, 1H, J=8.4 Hz, H5), 6.34 and 5.98 (s, 1H, Cp) 4.34 and 4.26 (s, 1H, H9 Flu), 3.06 and 3.00 (br s, 2H, Cp), 1.33 and 1.24 (each s, 9H, t-Bu, Flu), 1.23 and 1.19 (s, 9H, t-Bu, Cp), 1.40-1.15 (9H, Me-bridged+Me (Cp).

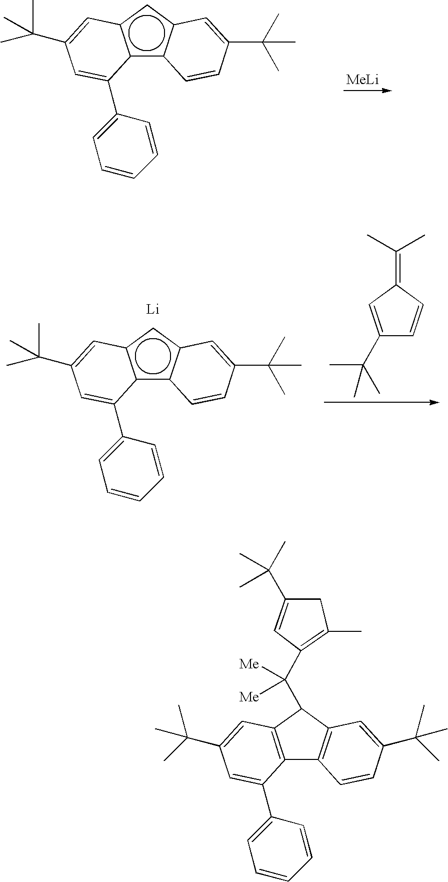

### EXAMPLE 13

### 2,2-[(3 -tert-3 -methyl-Cyclopentadienyl)-[(4-phenyl-2,7-di-tert-butylfluorenyl)]-propane]zirconium dichloride (Catalyst 4)

The same procedure as in Example 7 was repeated except that reaction was conducted by using the ligand from Example 12.

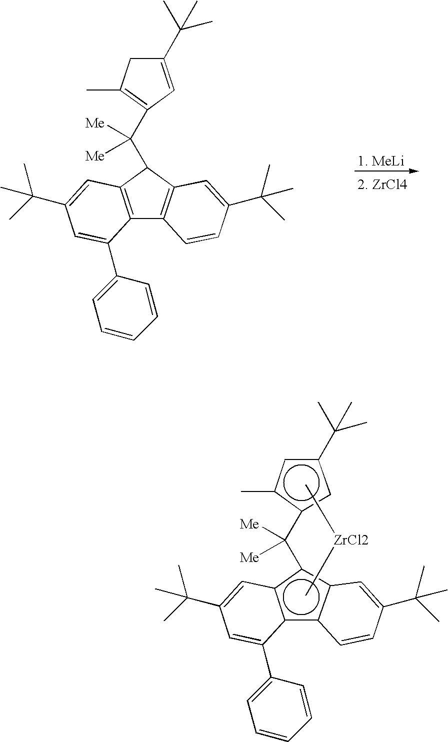

### EXAMPLE 14

### 2,2-[(3-tert-Butyl-5-methyl-cyclopentadienyl)-[(4-phenyl-fluorenyl)]-propane

The same procedure as in Example 12 was repeated except that reaction was conducted by using the fluorene from Example 4.

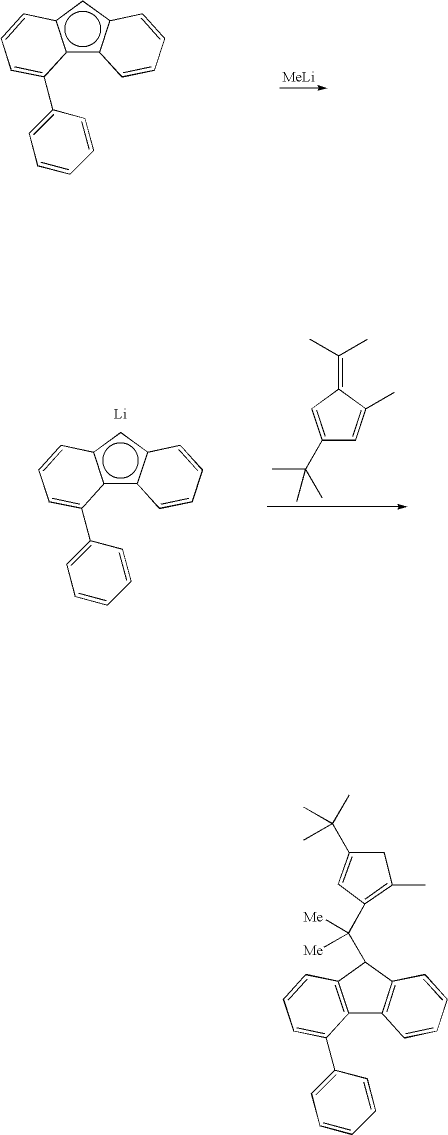

### EXAMPLE 15

### 2,2-[(3-tert-Butyl-3-methyl-cyclopentadienyl)-[(4-phenyl-fluorenyl)]-propane]zirconium dichloride (Catalyst 5)

The same procedure as in Example 7 was repeated except that reaction was conducted by using the ligand from Example 14.

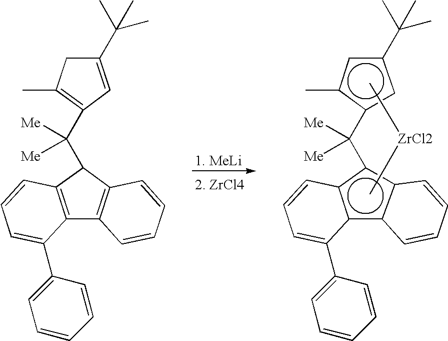

### EXAMPLE 16

### (3-tert-Butyl-cyclopentadienyl)-(4-phenyl-2,7-di-tert-butylfluorenyl)dimethylsilane

Methyllithium (2.8 ml, 1.6 M in Et₂O, 4.48 mmol) was added to 4-phenyl-2,7-di-t-butylfluorene (1.50 g, 4.24 mmol) in THF (20 ml) at −78° C. The reaction mixture was brought to room temperature and stirred for 4 hours. The reaction mixture was added to Me₂SiCl₂ (2.73 g, 21.2 mmol) in THF (20 ml) at 0° C. The reaction was stirred overnight at room temperature, and the solvents and excess Me₂SiCl₂ were removed under vacuum, yielding a yellow oil. THF (20 ml) was added to the crude product, and the suspension was cooled to 0° C. t-BuCpLi (0.56 g, 4.29 mmol), prepared from t-BuCp and BuLi in hexane, was added to the cold suspension, and the resulting mixture was stirred for an additional 10 hours at room temperature. The solvent was removed under vacuum. The product was purified by column chromatography (silica gel, hexane). Yield 1.05g, 46%. ¹H NMR (CD₂Cl₂): δ 7.40-7.60 (2H, H-Flu, overlap with Ph), 7.50 (m, 5H, Ph), 7.23 and 7.14 (d or br s, 1H, H-Flu,two isomers), 7.08, 7.00 (dd, 1H, J=8.1 Hz, J=1.5 Hz, H6 Flu from two isomers), 6.93, 6.80 (d, 1H, J=8.4 Hz, H5 Flu from two isomers), 6.54, 6.11, 5.63 and 5.54 (m, 2H, H(Cp) from two isomers), 3.90 and 3.93 (s, 2H, H9 from two isomers), 2.85-3.10 and 2.50-2.65 (m, 2H, H(Cp) from all isomers), 1.41 and 1.33 (each s, 9H, t-Bu)., 1.09 (s, 9H, t-Bu from Cp)

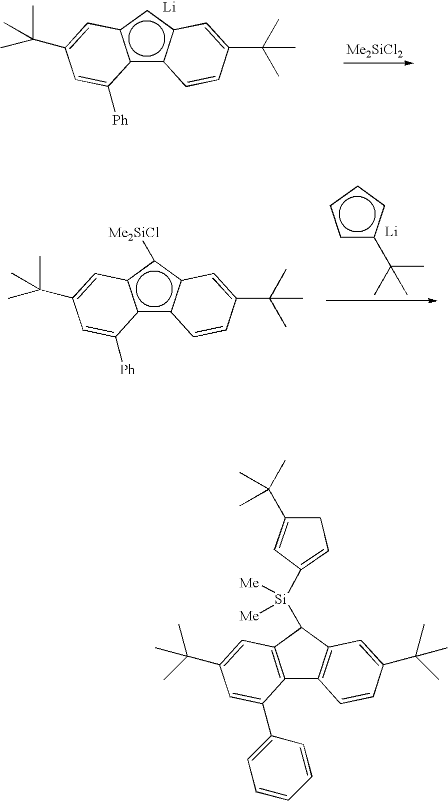

### EXAMPLE 17

### [(3-tert-Butyl-cyclopentadienyl)-(4-phenyl-2,7-di-tert-butylfluorenyl)dimethylsilane]zirconium dichloride (Catalyst 6)

Methyllithium (2.6 ml, 1.6M in Et₂O, 4.16 mmol) was added to (3-tert-butylcyclopentadienyl)-(4-phenyl-2,7-di-tert-butylfluorenyl)dimethylsilane (1.05 g, 1.97 mmol) in THF (20 ml) at −78° C. The reaction mixture was brought to room temperature and stirred for 5 hours. The solvent was evaporated under vacuum to afford the residue, which was washed with hexane. ZrCl₄ (0.459 g (1.97 mmol) was added. at −78° C. Ether (20 ml) was added to reaction mixture. The reaction mixture was brought to room temperature and stirred overnight. The solvent was removed under vacuum to afford the orange solid, which was tested in propylene polymerization without purification.

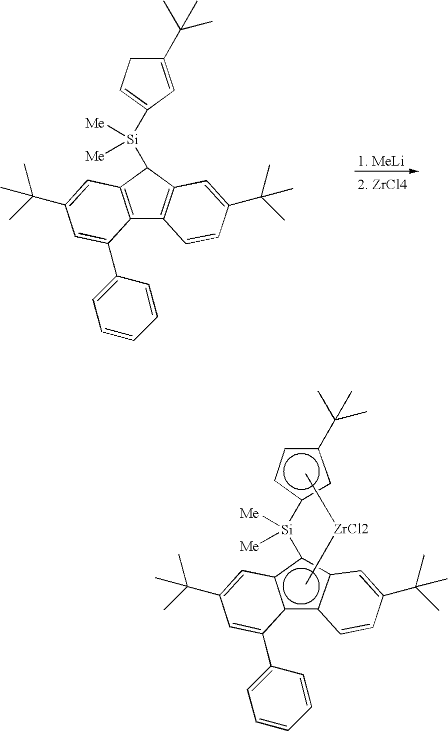

### EXAMPLE 18

### (3-tert-Butyl-5-methyl-cyclopentadienyl)-(4-phenyl-2,7-di-tert-butylfluorenyl)dimethylsilane

The same procedure as in Example 16 was repeated except that reaction was conducted by using the methyl-tert-buty-lcyclopentadienyl lithium

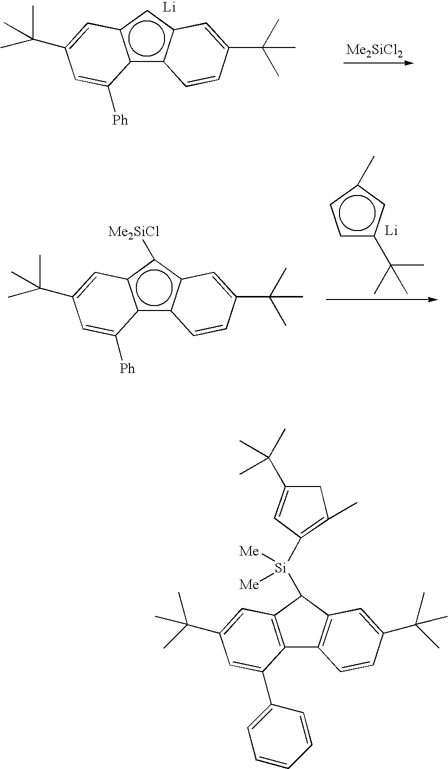

### EXAMPLE 19

### [(3-tert-Butyl-5-methyl-cyclopentadienyl)-(4-phenyl-2,7-di-tert-butylfluorenyl)dimethylsilane]zirconium dichloride (Catalyst 7)

The same procedure as in Example 17 was repeated except that reaction was conducted by using the ligand from Example 18.

### EXAMPLES 20-30 Propylene Polymerization

All polymerizations were carried out in a 2 L bench reactor. The reactor was charged with 700 g of propylene. Each polymerization was conducted by injecting a specified amount of the activated catalyst. The catalyst was activated with an MAO solution (30 wt. % in toluene) to provide an Al/Zr ratio of 1,000.

TABLE 1
Propylene polymerization (Bulk propylene, Zr/MAO = 1/1000, 1 h)

| | | | | | | Activity, g | | | |
|---|---|---|---|---|---|---|---|---|---|
| Example | Catalyst | mg | T, ° C. | H₂, ppm | PP, g | PP/g cat/h | M.p., ° C. | Mw | D |
| 20 | 1 | 20.0 | 60 | 0 | 50 | 2,500 | | 2,600 | |
| 21 | 3 | 20.0 | 60 | 0 | 15 | 750 | 155.0 | 670,000 | |
| 22 | 4 | 20.0 | 60 | 0 | 16 | 800 | 156.0 | 560,000 | |
| 23 | 6 | 8.5 | 50 | 0 | 32 | 3,800 | 151.5 (145.0) | 92,500 | 4.0 |
| 24 | 6 | 7.5 | 60 | 0 | 45 | 6,000 | 150.3 (142.4) | 57,600 | 3.8 |
| 25 | 6 | 30.0 | 60^{a} | 0 | 320 | 10,600 | 150.9 (142.2) | 52,200 | 3.5 |
| 26 | 6 | 8.3 | 70 | 0 | 72 | 8,700 | 150.5 (141.2) | 36,600 | 3.3 |
| 27 | 6 | 5.5 | 60 | 20 | 45 | 8,200 | 154.7 (149.4) | 42,200 | 3.3 |
| 28^{b} | 6 | 3.8 | 60 | 60 | 45 | 39,500 | 155.7 (148.7) | 30,100 | 3.3 |
| 29^{b} | 6 | 3.3 | 70 | 40 | 106 | 107,100 | 154.9 (147.9) | | |
| 30^{b} | 6 | 3.0 | 70 | 60 | 166 | 184,400 | 155.6 (148.5) | | |

^{a}Uncontrolled reaction temperature
^{b}Polymerization time 20 min

TABLE 2
Tacticity (% pentads) of PP produced (Data obtained from
13C NMR analysis of PP samples)

| | Exam- | Exam- | Example | | |
|---|---|---|---|---|---|
| | ple 23 | ple 24 | 26 | Example 27 | Example 28 |
| mmmm | 85.1 | 81.7 | 85.2 | 86.6 | 88.4 |
| mmmr | 5.7 | 6.9 | 5.6 | 5.0 | 4.7 |
| rmmr | 0.3 | 0.5 | 0.3 | 0.3 | 0.4 |
| mmrr | 4.4 | 5.9 | 4.4 | 4.2 | 3.2 |
| xmrx | 1.3 | 1.2 | 1.3 | 1.1 | 1.1 |
| mrmr | 0.4 | 0.3 | 0.4 | 0.2 | 0.1 |
| rrrr | 0.1 | 0.4 | 0.3 | 0.4 | 0.4 |
| rrrm | 0.4 | 0.3 | 0.4 | 0.1 | 0.0 |
| mrrm | 2.3 | 2.9 | 2.2 | 2.0 | 1.5 |
| % meso | 94.1 | 92.7 | 94.0 | 94.7 | 95.8 |
| % racemic | 5.9 | 7.3 | 6.0 | 5.3 | 4.2 |
| % error | 1.0 | 1.0 | 1.0 | 0.9 | 1.0 |
| def/1000 C. | 29.3 | 36.3 | 29.8 | 26.3 | 21.0 |

As indicated by the foregoing experimental work, catalysts embodying the present invention are highly effective in the polymerization of propylene to produce isotactic polypropylene. Normally, the isotactic polypropylene produced in accordance with the present invention will take the form of propylene homopolymer, although small amounts of co-monomers, such as ethylene, typically in amounts less than 5 weight % of the total feedstream, may be employed. In the course of producing isotactic polypropylene in accordance with the present invention, it is preferred to employ a catalyst component characterized by formula (6) above in which both the cyclopentadienyl group and the fluorenyl group are substituted. The cyclopentadienyl group is preferably substituted at the 3 position with a tertiary butyl group or a similarly relatively bulky group and at the 5 position with a substituent of lower molecular weight. Specifically, the cyclopentadienyl group may take the form of substituents with an isobutyl group at the 3 position and a methyl group at the 5 position. The fluorenyl group preferably is di-substituted at the 2 and 7 positions as described previously and also substituted at the 4 position with a phenyl group or substituted phenyl group. Especially preferred catalyst components for use in carrying out the invention to produce isotactic polypropylene are ligand structures characterized by 3-tertiary butyl cyclopentadienyl, 2,7-ditertiary butyl, 4-phenyl (or 4-tertiary butyl) fluorenyl group and the corresponding ligand structure which is also substituted on the cyclopentadienyl group at the 5 position with a methyl group.

Having described specific embodiments of the present invention, it will be understood that modifications thereof may be suggested to those skilled in the art, and it is intended to cover all such modifications as fall within the scope of the appended claims.

1. A olefin polymerization catalyst characterized by the formula
B(FluA)MQₙ (3)
wherein:
a. Flu is a fluorenyl group substituted at at least one of the 4,5 positions by a bulky hydrocarbyl group containing at least four carbon atoms;
b. A is a substituted or an unsubstituted cyclopentadienyl group, a substituted or unsubstituted indenyl group, or a heteroorgano group XR in which X is a heteroatom from Group 15 or 16 of the Periodic Table, and R is an alkyl group, a cycloalkyl group or an aryl group containing from 1 to 20 carbon atoms;
c. B is a structural bridge between A and Flu imparting stereorigidity to the ligand structure (FluA);
d. M is a Group 4 or Group 5 transition metal;
e. Q is selected from the group consisting of Cl, Br, I, an alkyl group, an amino group, an aromatic group and mixtures thereof; and
f. n is 1 or 2.

2. The catalyst composition of claim 1 wherein Flu is substituted at both of the 4 and 5 positions with a bulky hydrocarbyl group containing at least four carbon atoms.

3. The catalyst composition of claim 1 wherein Flu is mono-substituted at the 4(5) position and is otherwise unsubstituted.

4. The catalyst composition of claim 1 wherein Flu is mono-substituted at the 4(5) position and is di-substituted at the 2,7 positions with alkyl groups, phenyl or substituted phenyl groups, which may be the same or different.

5. The catalyst composition of claim 4 wherein the fluorenyl group Flu is di-substituted at the 2,7 positions with substituents of a lower molecular weight than the substituent at the 4(5) position.

6. The catalyst composition of claim 4 wherein the fluorenyl group Flu is di-substituted at the 3,6 position with alkyl groups of a lower molecular weight than the substituent at the 4(5) position.

7. The catalyst composition of claim 1 wherein A is a heteroorgano group XR and X is N, P, O or S.

8. The composition of claim 6 wherein 7 is N and R is a mononuclear aromatic group or an alkyl group or cycloalkyl group containing from 1-20 carbon atoms.

9. The composition of claim 1 wherein said structural bridge B is characterized by the formula ER′R″ wherein E is C, Si or Ge and R′ and R″ are each independently an alky group, an aromatic group or a cycloalkyl group.

10. The composition of claim 1 wherein A is a substituted or unsubstituted cyclopentadienyl group.

11. The composition of claim 10 wherein M is titanium, zirconium or hafnium.

12. The composition of claim 11 wherein Flu is substituted at one of the 4 or 5 positions with a phenyl group which is substituted or unsubstituted.

13. The composition of claim 12 wherein A is cyclopentadienyl group substituted at the 3 position with a tertiary butyl group.

14. The composition of claim 13 wherein said cyclopentadienyl group is substituted at the 5 position with a methyl group.

15. The composition of claim 13 wherein said fluorenyl group is di-substituted at the 2,7 positions with isopropyl or tertiary butyl groups.

16. An olefin polymerization catalyst characterized by the formula 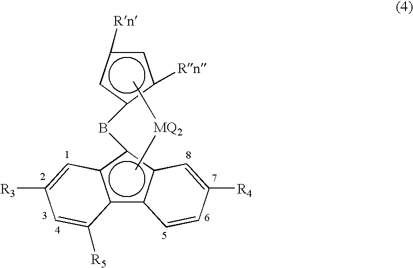
wherein:
a. R′ is a C₁-C₄ alkyl group or an aryl group;
b. R″ is a methyl group or an ethyl group;
c. n′ is 0 or 1;
d. n″ is 0 or 1;
e. B is a structural bridge between the fluorenyl and cyclopentadienyl groups;
f. M is titanium, zirconium or hafnium;
g. Q is selected from the group consisting of Cl, Br, I, an alkyl group, an amino group, an aromatic group and mixtures thereof;
h. R₃ and R₄ are the same or different and are each a hydrogen or an isopropyl group or a tertiary butyl group, or phenyl, or substituted phenyl group; and
i. R₅ is an alkyl or aromatic group which has a higher molecular weight than R₃ or R₄.

17. The catalyst of claim 16 wherein R′ is a tertiary butyl group and n′ is 1, R₃ and R₄ are each tertiary butyl groups and R₅ is a substituted or unsubstituted phenyl group.

18. The catalyst composition of claim 17 wherein n″ is 1.

19. The catalyst of claim 18 wherein R″ is a methyl group.

20. The composition of claim 17 wherein R₅ is a 4-tertiary butyl phenyl group.

21. An olefin polymerization catalyst characterized by the formula 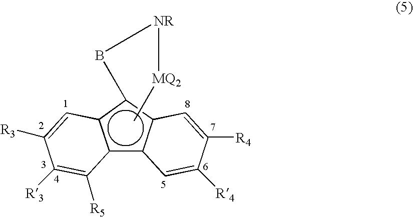
wherein:
a. R is a mononuclear aromatic group, or an alkyl group or cycloalkyl group containing from 1-20 carbon atoms;
b. B is a structural bridge between the fluorenyl group and the heteroatom group NR;
c. M is titanium, zirconium or hafnium;
d. Q is selected from the group consisting of Cl, Br, I, an alkyl group, an amino group, an aromatic group and mixtures thereof;
e. R₃ and R₄ are the same or different and are each a hydrogen or a C₁-C₄ alkyl group, or phenyl, or substituted phenyl group;
f. R′₃ and R′₄ are each hydrogen or a C₁-C₄ alkyl group providing that when R₃ and R₄ are hydrogen, R′₃ and R′₄ are hydrogen; and
g. R₅ is an alkyl or aromatic group which has a higher molecular weight than R₃ or R₄.

22. The catalyst of claim 21 wherein R₃ and R₄ are each a tertiary butyl group, R′₃ and R′₄ are each a C₁-C₄ alkyl group and R₅ is a substituted or unsubstituted phenyl group.

23. The composition of claim 22 wherein R is tertiary butyl group.

24. The catalyst of claim 21 wherein R₃ and R₄ are each hydrogen and R₅ is a tertiary butyl group, a phenyl group, or a substituted phenyl group.

25. An olefin polymerization catalyst characterized by the formula 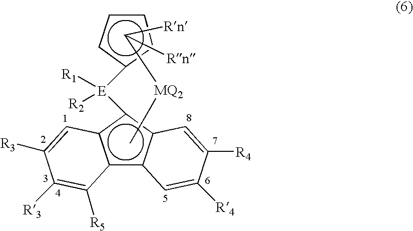
wherein:
a. R′ is a C₁-C₄ alkyl group or an aryl group;
b. n′ is from 0 to 3;
c. R″ is an alkyl group of a lower molecular weight than R′;
d. n″ is 0 or 1;
e. E is —C— or —Si—;
f. R₁ and R₂ are the same or different and are each a methyl group, a phenyl group or a substituted phenyl group;
g. M is titanium, zirconium or hafnium;
h. Q is a chlorine, a methyl group or a phenyl group;
i. R₃ and R₄ are the same or different and are each a hydrogen or a C₁-C₄ alkyl group, or phenyl, or substituted phenyl group;
j. R′₃ and R′₄ are each hydrogen or a C₁-C₄ alkyl group provided that when R₃ and R₄ are hydrogen, R′₃ and R′₄ are hydrogen; and
k. R₅ is an alkyl group or aromatic group which has a higher molecular weight than R₃ or R₄.

26. The catalyst of claim 25 wherein n′ and n″ are 0, R₃ and R₄ are each hydrogen, and R₅ is a tertiary butyl group or a substituted or unsubstituted phenyl group.

27. The catalyst of claim 25 wherein R₃ and R₄ are each independently a C₁-C₄ alkyl group and R₅ is a substituted or unsubstituted phenyl group.

28. The catalyst composition of claim 25 wherein R₃ and R₄ are tertiary butyl groups, R₅ is a substituted or unsubstituted phenyl group and n′ and n″ are each 0.

29. The catalyst composition of claim 25 wherein n′ is 1 and R′ is a tertiary butyl group substituted on said cyclopentadienyl group at the 3 position.

30. The catalyst composition of claim 29 wherein R₃ and R₄ are tertiary butyl groups and R₅ is a phenyl group or a 4-tertiary butyl phenyl group.

31. The catalyst composition of claim 29 wherein n″ is 1 and R″ is a methyl group substituted on said cyclopentadienyl group at the 5 position.

32. A process for the polymerization of an ethylenically unsaturated monomer comprising:
a. providing a transition metal catalyst characterized by the formula
B(FlA)MQₙ (3)
wherein:
i. Flu is a fluorenyl group substituted at at least one of the 4,5 positions by a bulky hydrocarbyl group containing at least four carbon atoms;
ii. A is a substituted or an unsubstituted cyclopentadienyl group, a substituted or unsubstituted indenyl group, or a heteroorgano group XR in which X is a heteroatom from Group 15 or 16 of the Periodic Table, and R is an alkyl group, a cycloalkyl group or an aryl group containing from 1 to 20 carbon atoms;
iii. B is a structural bridge between A and Flu, imparting stereorigidity to the ligand structure (FlA);
iv. M is a Group 4 or Group 5 transition metal;
v. Q is selected from the group consisting of Cl, Br, I, an alkyl group, an aromatic group and mixtures thereof; and
vi. n is 1 or 2;
b. providing an activating cocatalyst component;
c. contacting said catalyst component and said cocatalyst component in a polymerization reaction zone with an ethylenically unsaturated monomer under polymerization conditions to produce a polymer product by polymerization of said monomer; and
d. recovering said polymer product from said reaction zone.

33. The process of claim 32 wherein said monomer comprises propylene and said polymer product is a polypropylene homopolymer or copolymer.

34. The process of claim 33 wherein said transition metal catalyst is characterized by the formula 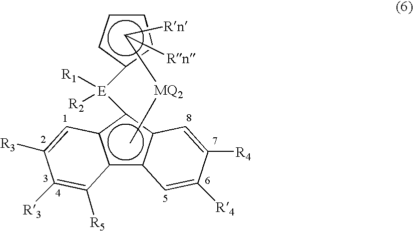
wherein:
a. R′ is a C₁-C₄ alkyl group or an aryl group;
b. n′ is from 0 to 3;
c. R″ is an alkyl group of a lower molecular weight than R′;
d. n″ is 0 or 1;
e. E is —C— or —Si—;
f. R₁ and R₂ are the same or different and are each a methyl group, a phenyl group or a substituted phenyl group;
g. M is titanium, zirconium or hafnium;
h. Q is a chlorine, a methyl group or a phenyl group;
i. R₃ and R₄ are the same or different and are each a hydrogen or a C₁-C₄ alkyl group or phenyl, or substituted phenyl group;
j. R′₃ and R′₄ are each hydrogen or a C₁-C₄ alkyl group provided that when R₃ and R₄ are hydrogen, R′₃ and R′₄ are hydrogen;
k. R₅ is an alkyl group or aromatic group which has a higher molecular weight than R₃ or R₄;
and said polymer product is an isotactic polypropylene.

35. The process of claim 33 wherein n′ is 1 and R′ is a tertiary butyl group substituted on said cyclopentadienyl group at the 3 position.

36. The process of claim 34 wherein R₃ and R₄ are tertiary butyl groups and R₅ is a phenyl group or a 4-tertiary butyl phenyl group.

37. The process of claim 35 wherein n″ is 1 and R″ is a methyl group substituted on said cyclopentadienyl group at the 5 position.
